(19) United States
(12) Patent Application Publication
(10) Pub. No.: US 2006/0156011 A1
(43) Pub. Date: Jul. 13, 2006

(54) Network device having time correction function

(76) Inventor: Takanori Masui, Ebina-shi (JP)

Correspondence Address: GAUTHIER & CONNORS, LLP, 225 FRANKLIN STREET, BOSTON, MA, 02110, US

(21) Appl. No.: 11/204,875

(22) Filed: Aug. 16, 2005

(30) Foreign Application Priority Data
Jan. 13, 2005 (JP) 2005-006839

(51) Int. Cl. H04L 9/00

(52) U.S. Cl. 713/178

(57) ABSTRACT

A network device which is provided. This device is connected to a network, and includes an internal clock, a time information obtaining section that obtains time information from a time server on the network, a time correcting section that corrects the internal clock based on the time information; wherein when a period of time between the time information and time indicated by the internal clock is less than or equal to a predetermined period of time, the time correcting section corrects the internal clock based on the time information, and, when the period of time between the time information and the time indicated by the internal clock exceeds the predetermined period of time, the time correcting section corrects the internal clock based on the time information only if the internal clock has not been corrected.

### PRIORITY INFORMATION

This application claims priority to Japanese Patent Application No. 2005-006839, filed Jan. 13, 2005, which is incorporated herein by reference in its entirety.

### BACKGROUND OF THE INVENTION

1. Field of the Invention

The present invention relates to a network device such as a computer and a peripheral device which is connected to a network, and, in particular, to time correction of a clock provided in the network device.

2. Description of the Related Art

Conventionally, time synchronization protocols such as NTP (Network Time Protocol) and SNTP (Simple Network Time Protocol), which is a simplified version of NTP, are used in order to match the time of an internal clock of a computer with a master clock to which it is connected via a data communication network, such as the Internet or a LAN.

In recent years, it has become more common for digital multifunction centers (devices that also have functions of a network printer, a network scanner, a copier, etc.) to be connected to a data communication network, and devices having a processing function that requires time synchronization with a device on the network such as a PKI (Public Key Infrastructure) function and Kerberos (trademark) authentication function have been introduced and are being further developed. Because of this, there are also ongoing efforts to develop digital multifunction centers in which the time displayed by an internal clock can be corrected through a time synchronization protocol such as SNTP.

In the framework of time correction (synchronization) using time synchronization protocol, in general, a time server (for example, an NTP server) which provides accurate time information is provided on a network and each client device (for example, digital multifunction center) periodically accesses the time server to obtain time information and corrects the time of the internal clock using the time information.

Time correction through time synchronization protocol is, however, vulnerable to attacks such as “spoofing”, in which false messages provide erroneous time information to a client device to alter the internal clock of the client device. For example, an attack may be considered in which the internal clock of the device is set back so that the device erroneously determines an expired public key certificate to be valid.

As one countermeasure to such a spoofing, a method to determine whether or not time information can be trusted by attaching an electronic signature of the time server itself to the time information provided by the time server and verifying, by the client device, the electronic signature of the received time information is known.

Although this method does provide an effective countermeasure to spoofing, it cannot be employed in many cases because most existing NTP servers do not have an electronic signature attaching function. One reason for this is that, because the process of attaching an electronic signature requires a certain amount of calculation cost, it is not preferable to apply such a high calculation load to the NTP server which receives time information requests from many client devices. In addition, because verification of the electronic signature also requires a certain amount of calculation cost, it is preferable to avoid verification of an electronic signature in a device which demands real-time responsiveness to an operation more strongly than a personal computer. This demand is strong particularly in, for example, a device having relatively limited amount of calculation resources such as digital multifunction centers.

In addition, in NTP, a method is employed in which time information is obtained by the client device from three or more NTP servers so that, even when inaccurate time information is provided intentionally by an attacker or through malfunctioning from any of the NTP servers, such an inappropriate server can be identified and the time information from the inappropriate server is not used.

But, determining whether a server is inappropriate by obtaining time information from three or more servers as in NTP requires a high processing load of the client device and is not suited for devices such as digital multifunction centers.

### SUMMARY OF THE INVENTION

According to one aspect, the present invention provides a network device which is connected to a network and includes an internal clock, a time information obtaining section that obtains time information from a time server on the network, a time correcting section that corrects the internal clock based on the time information; wherein when a period of time between the time information and time indicated by the internal clock is less than or equal to a predetermined period of time, the time correcting section corrects the internal clock based on the time information, and, when the period of time between the time information and the time indicated by the internal clock exceeds the predetermined period of time, the time correcting section corrects the internal clock based on the time information only if the internal clock has not been corrected.

According to another aspect, the present invention provides a network device which is connected to a network and includes an internal clock, a time information obtaining section that obtains time information from a plurality of time servers on the network, and a time correcting section that corrects the internal clock based on the time information; wherein when a period of time between time information obtained from a first time server and time indicated by the internal clock is less than or equal to a predetermined period of time, the time correcting section corrects the internal clock based on the time information obtained from the first time server, and, when the period of time between the time information obtained from the first time server and the time indicated by the internal clock exceeds the predetermined period of time, the time correcting section corrects the internal clock based on time information obtained from a second time server only if a period of time between the time information obtained from the second time server and the time indicated by the internal clock is less than or equal to the predetermined period of time.

According to another aspect, the present invention provides a method of correcting an internal clock which is built into a network device, the method includes obtaining time information from a time server on the network, and correcting the internal clock based on the time information; wherein when a period of time between the time information and time indicated by the internal clock is less than or equal to a predetermined period of time, the internal clock is corrected based on the time information; and when the period of time between the time information and the time indicated by the internal clock exceeds the predetermined period of time, the internal clock is corrected only if the internal clock has not been corrected.

According to another aspect, the present invention provides a method of correcting an internal clock which is built into a network device, the method includes obtaining time information from a plurality of time servers on the network; and correcting the internal clock based on the time information; wherein when a period of time between time information obtained from a first time server and time indicated by the internal clock is less than or equal to a predetermined period of time, the internal clock is corrected based on the time information, and when the period of time between the time information obtained from the first time server and the time indicated by the internal clock exceeds the predetermined period of time, the internal clock is corrected based on time information obtained from a second time server only if a period of time between the time information obtained from the second time server and the time indicated by the internal clock is equal to or less than the predetermined period of time.

According to another aspect, the present invention provides a storage medium readable by a computer, the storage medium storing a program of instructions executable by the computer having an internal clock to perform a function which includes obtaining time information from a time server on the network, and correcting the internal clock based on the time information; wherein when a period of time between the time information and time indicated by the internal clock is less than or equal to a predetermined period of time, the internal clock is corrected based on the time information; and when the period of time between the time information and the time indicated by the internal clock exceeds the predetermined period of time, the internal clock is corrected only if the internal clock has not been corrected.

According to another aspect, the present invention provides a storage medium readable by a computer, the storage medium storing a program of instructions executable by the computer having an internal clock to perform a function which includes obtaining time information from a plurality of time servers on the network, and correcting the internal clock based on the time information; wherein when a period of time between time information obtained from a first time server and time indicated by the internal clock is less than or equal to a predetermined period of time, the internal clock is corrected based on the time information, and when the period of time between the time information and the time indicated by the internal clock exceeds the predetermined period of time, the internal clock is corrected based on time information obtained from a second time server only if a period of time between the time information obtained from the second time server and the time indicated by the internal clock is equal to or less than the predetermined period of time.

### BRIEF DESCRIPTION OF THE DRAWINGS

An embodiment of the present invention will be described in detail based on the following figures, wherein:

FIG. 1 is a diagram showing a first example system using a network time correction method according to an embodiment of the present invention;

FIG. 2 is a flowchart showing a procedure of a time correction process in the first example system;

FIG. 3 is a diagram showing a second example system using a network time correction method according to an embodiment of the present invention; and

FIG. 4 is a flowchart showing a procedure of a time correction process in the second example system.

### DETAILED DESCRIPTION OF THE INVENTION

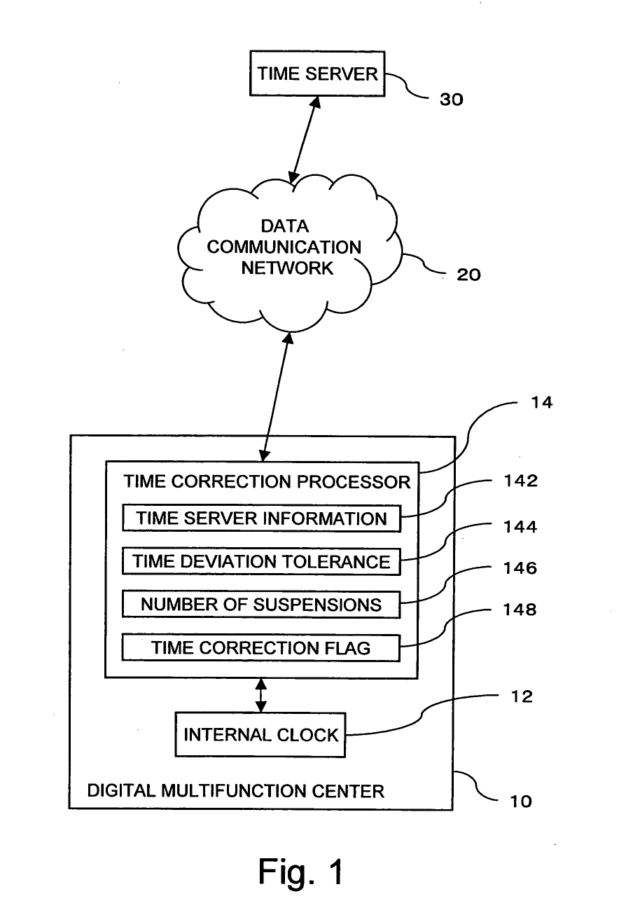

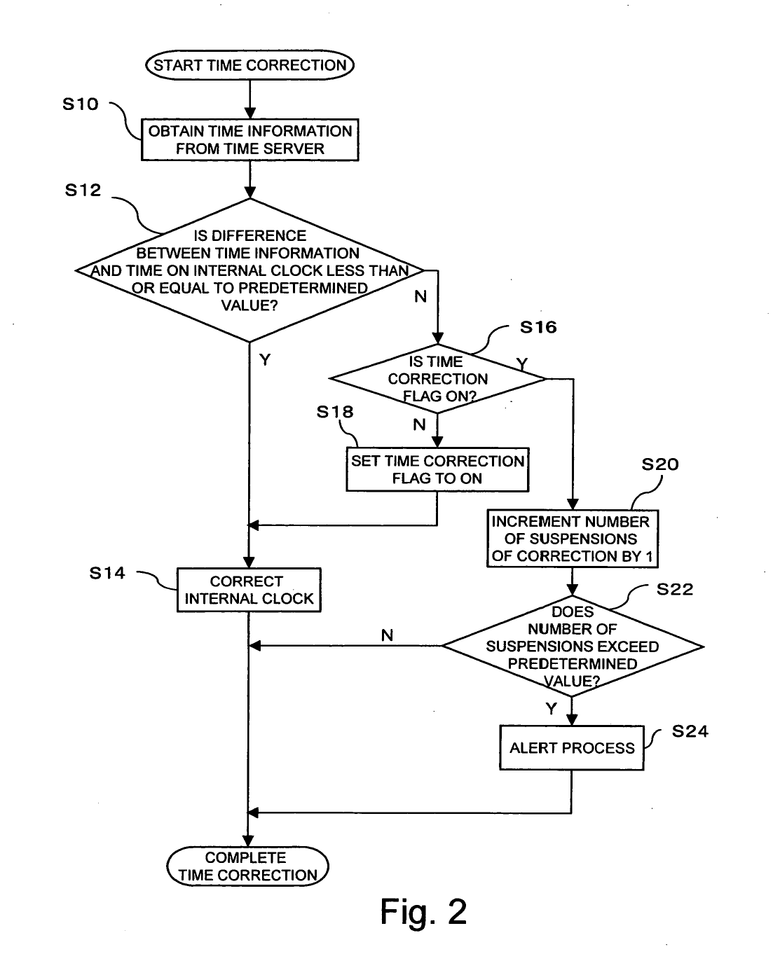

A first example system using a network time correction method according to an embodiment of the present invention will now be described referring to FIGS. 1 and 2.

This system includes a digital multifunction center 10 and a time server 30 connected to a data communication network 20 such as the Internet and LAN.

The time server 30 may be a server which conforms with an existing time synchronization protocol such as an NTP server and an SNTP server.

The digital multifunction center 10 includes an internal clock 12 and a time correction processor 14 which corrects the time indicated by the internal clock 12 according to the time server 30.

The time correction processor 14 conforms with a protocol having a relatively light processing load such as SNTP, which is a simplified form of NTP, and is typically realized by a calculation processing device (processor) executing a control program installed to a built-in storage device of the digital multifunction center 10.

The time correction processor 14 stores time server information 142, a time deviation tolerance 144, number of suspension 146, and a time correction flag 148. The time server information is address information (such as, for example, IP address) of the time server to be used for the time correction process. The time deviation tolerance 144 is a tolerable limit amount of deviation indicating a limit, of a degree of deviation of time between the time information obtained from the time server 30 and the time indicated based on the internal clock 12, for which the time correction of the internal clock 12 by the time information is permitted. The time server information 142 and time deviation tolerance 144 are stored in advance by a manufacturer or an administrator of the digital multifunction center 10. The number of suspensions 146 indicates a number in which the correction is suspended because of a time deviation exceeding the time deviation tolerance 144 through repetitious execution of time corrections. The time correction flag 148 is flag information indicating whether or not the time correction processor 14 has corrected, in the past, the internal clock 12 based on the time information from the time server 30. The time correction flag 148 is set to OFF (that is, no time correction is completed) when the digital multifunction center 10 is shipped from a factory. The time correction processor 14 executes a time correction process through a procedure shown in FIG. 2 using these items of information every time a predetermined timing occurs. Examples of the correction timing include, for example, a periodic timing such as every day at noon, every Monday at noon, etc.; during startup of the device; a timing when a time correction process is instructed by an operator or an external device; a timing when a job is started (that is, before the job starts); a timing when a user operates the console panel of the device (by, for example, pressing a job start button or a mode switch operation button); etc.

Specifically, in the time correction process, the time correction processor 14 first accesses the time server 30 using the time server information 142 to request time information and obtains the time information provided by the time server 30 in response to the request (S10). Then, the time correction processor 14 determines whether or not a difference (deviation) between the obtained time information and the time of the internal clock 12 is less than or equal to the time deviation tolerance 144 (S12). When the difference is less than or equal to the time deviation tolerance 144, the time correction processor 14 corrects the time of the internal clock 12 according to the obtained time information (S14).

When, on the other hand, it is determined in the determination of step S12 that the difference between the obtained time information and the time of the internal clock 12 exceeds the time deviation tolerance 144, the time correction processor 14 checks the time correction flag 148 (S16). When it is determined in this determination that the time correction flag 148 is off (correction has not been executed), the time correction flag 148 is set to “ON” (S18) and the internal clock 12 is corrected according to the time information (S14). When, on the other hand, it is determined that the time correction flag 148 is ON in the determination of the step S16 (that is, time has been corrected), the time correction at this time is suspended.

More specifically, in the first configuration, the time correction process is basically permitted only when the period of time to be corrected is less than or equal to the time deviation tolerance 144, with the exception of the first time correction after the digital multifunction center 10 is equipped for the user. This configuration is based on the following reason. First, the time correction is only permitted when the period of time to be corrected is less than or equal to the time deviation tolerance 144 because the time server may be under attack by spoofing or the like or the time server 30 may be impaired when the time deviation between the time information of the time server 30 and the time of the internal clock 12 is larger than the time deviation tolerance. If the time is corrected based on the time information in such a case, the internal clock 12 may be significantly deviated and malfunctioning may result. Second, the time correction exceeding the time deviation tolerance 144 is permitted when the time correction flag 148 is OFF (that is, the first correction) because the time of the internal clock 12 may greatly deviate from actual time when the device is provided to the user. Moreover, a human error may occur when the device is initially set such as a manual setting of an erroneous time by the merchant or factory. In the first configuration, even when the time of the internal clock 12 significantly deviates from the correct time because of these reasons, the internal clock 12 can be automatically corrected using the time server 30 if the correction is the first correction. The time deviation tolerance 144 may be set as the maximum value of time that the internal clock 12 can be deviated between time periods of time correction even when all operations normally proceed. The time deviation tolerance 144 may also be a value in which a suitable safety coefficient larger than 1 is multiplied to this value.

In the procedure of FIG. 2, when it is determined that the time correction flag 148 is ON in step S16, the time correction processor 14 does not perform the time correction process (S14) and increments the number of suspensions 146 which indicates the number of suspensions of the time correction by 1 (S20). Then, the number of suspensions 146 is compared with a threshold which is set in advance (S22). When the number of suspensions 146 is less than or equal to the threshold value, the process is simply completed, and, when the number of suspensions 146 exceeds the threshold value, an alert process is performed to output a predetermined alert (S24). The output of the alert may be realized by displaying an alert message on a user interface screen of the digital multifunction center 10 or by notifying through an electric mail to a mailing address of the administrator which is registered in advance. Alternatively, it is also possible to output the alert by recording the alert on an event log or the like. When the method of recording the alert on an event log is employed, an administrator viewing the log can understand that an abnormality has occurred. In addition, when the alert is recorded on the event log, it is also possible to perform a process to monitor the log by a predetermined monitoring device and to notify the administrator when the monitoring device detects a log indicating an alert.

Specifically, in this configuration, when suspension of the time correction due to time deviation in an amount greater than or equal to the time deviation tolerance 144 frequently occurs, there is a possibility of an attack from the outside or failure of the internal clock 12, and, therefore, a notification is sent to the administrator or the like. The number of suspensions may be counted by a simple counting process or, alternatively, number of suspensions occurring in succession may be counted (that is, the count value is cleared after the time correction process is executed). The threshold value in the determination of S22 will differ between the former case and the latter case.

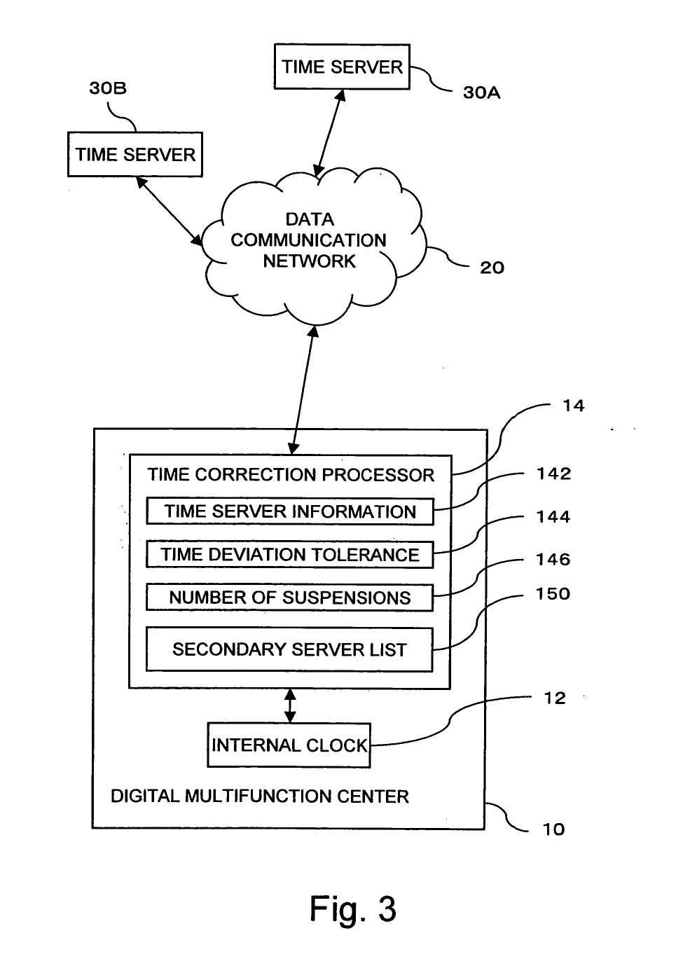

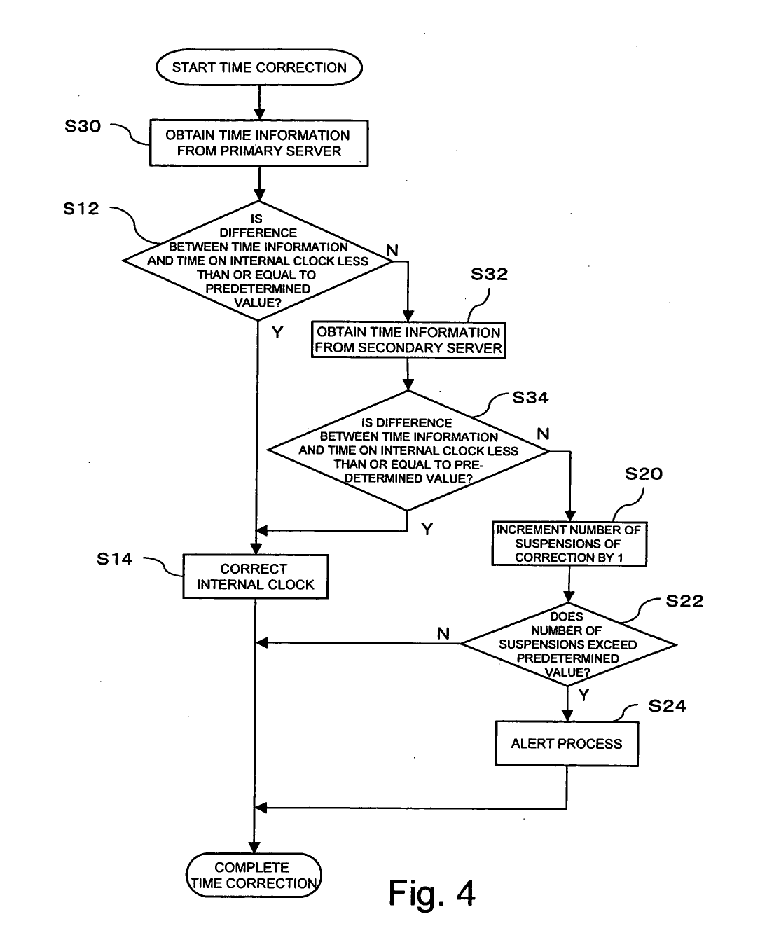

Next, a second configuration of a system which uses the network time correction method according to an embodiment of the present invention will be described referring to FIGS. 3 and 4. In FIGS. 3 and 4, components and steps that are similar to the components and steps in FIGS. 1 and 2 are assigned the same reference numerals and will not be described again.

In the system of the second configuration, the time correction processor 14 of the digital multifunction center 10 uses a plurality of time servers 30A, 30B, . . . for the time correction process. Although a plurality of time servers are used, the configuration differs from the NTP in which time information is received from the plurality of time servers 30 and used every time the time is received and the time correction is performed. In the present invention, in usual cases, time information from one time server registered to the time server information 142 (which, in this description, is called “30A”), and another time server among time servers provided as secondary time servers (for example, time server 30B) is accessed and the time correction process is executed only when the time information from the time server 30A is deviated from the time of the internal clock 12 by an amount greater than or equal to the time deviation tolerance 144.

In the following description, the time server 30A which is indicated in the time server information 142 and is normally accessed is called a “primary server” and the secondary time server 30B or the like which is only accessed when the time of the primary server 30A and the time of the internal clock 12 significantly differ from each other is called a “secondary server”. The time correction processor 14 stores a list of address information of one or more secondary servers as a secondary server list 150. In addition, the time correction processor 14 has information on the time deviation tolerance 144 and the number of suspensions 146. The time correction processor 14 executes a time correction process through a procedure as shown in FIG. 4 using these information every time a predetermined correction timing is reached.

In the processing procedure, first, the time correction processor 14 refers to address information registered in the time server information 142 and obtains time information from the primary server 30A (S30). Then, the time correction processor 14 compares the obtained time information with the time of the internal clock 12 (S12). When a difference between the obtained time information and the time of the internal clock is less than or equal to the time deviation tolerance 144, the time of the internal clock 12 is corrected according to the time information (S14). When, on the other hand, it is determined in step S12 that the difference between the time information and the internal clock 12 exceeds the time deviation tolerance 144, the time correction processor 14 obtains access information of a secondary server (for example, 30B) from the secondary server list and obtains time information from the secondary server using the access information (S32). The time correction processor 14 compares the obtained time information and the time of the internal clock 12 (S34). When a difference between the obtained time information and the time of the internal clock 12 is less than or equal to the time deviation tolerance 144, the time correction processor 14 corrects the time of the internal clock 12 according to the obtained time information (S14). When, on the other hand, it is determined in step S34 that the difference between the time information from the alternative time server and the time of the internal clock 12 exceeds the time deviation tolerance 144, the time correction is suspended.

In the second configuration, normally, the time correction process is executed using only the primary server 30A. The time information is obtained from the secondary server 30B for attempting a time correction process when the time information from the primary server 30A is deviated by an amount greater than the time deviation tolerance 144, because there is a possibility of an attack. An attempt to alter the time by spoofing the primary server 30A will not succeed because the attacker cannot spoof as the secondary server 30B as long as the attacker does not know the secondary server 30B to which the time correction processor 14 next inquires. It is very difficult to specify both the primary server 30A which is normally used and the secondary server 30B, which is accessed only on occasion. Therefore, the internal clock 12 can be accurately corrected by the time information from the secondary server 30B, except for rare, abnormal cases in which the secondary server 30B accidentally fails when the time correction processor 14 accesses the secondary server 30B or the internal clock 12 itself fails and the time is significantly deviated from the correct time.

Addresses of a plurality of secondary servers may be registered in the secondary server list 150 and one of the secondary servers to be used in step S32 may be selected at random.

In this procedure, when the time information obtained from the secondary server 30B also significantly differs from the time of the internal clock 12, the time correction process is suspended because there is a possibility that the internal clock 12 may be broken. In such a case, in FIG. 4, the number of suspensions 146 is incremented by 1 (S20) similar to the procedure of FIG. 2. When the number of suspensions 146 is less than or equal to a threshold value, the process is simply completed and, when the number of suspensions 146 exceeds the threshold value, a process is performed to output a predetermined alert (S24).

In the procedure of FIG. 4., when the time information from the secondary server 30B significantly differs from the time of the internal clock (S34), the time correction process is suspended. Alternatively, it is also possible to employ a configuration in which time information is obtained from another server to attempt time correction. With such a configuration, even when the primary server 30A is under the spoofing attack and the secondary server 30B is accidentally failing, the time correction process can be executed using the another server.

Although two example configurations of the time correction process according to the present invention have been described, it is also possible to add following additional processes to these configurations.

For example, a first additional process relates to handling of a public key certificate (self-signed certificate) by a self-signature generated by the digital multifunction center 10. More specifically, some recently-developed digital multifunction centers 10 include functions to generate a secret key and a self-signed certificate for SSL (Secure Socket Layer) and electrical signature. Public key certificates, including a self-signed certificate, contain information indicating their issue date. Because the issue date is determined from the internal clock 12, the validity of the certificate would be in question if the internal clock 12 significantly differs from the accurate time, and, therefore, the certificate may not be accepted by other devices on the network. For example, when a secret key and a self-signed certificate are generated in a state in which the internal clock 12 significantly differs from the correct time because the digital multifunction center 10 is being placed for the first time and no time correction has been performed, such a problem may occur.

In consideration of this situation, in the first additional process, a control program of the digital multifunction center 10 monitors a change of the time of the internal clock 12. When the control program detects that the time of the internal clock 12 has been significantly changed through a time correction process, the secret key and the self-signed certificate are regenerated. The determination of whether or not the time of the internal clock 12 has been significantly changed can be based on whether or not an amount of change between the value before the correction and the value after the correction exceeds a predetermined threshold value (it is possible to use the time deviation tolerance 144 as the threshold value). By providing such a function to execute such an additional process in the digital multifunction center 10, it is possible to automatically generate the secret key and the self-signed certificate according to the date and time indicated in the internal clock 12 after time correction when, for example, the time of the internal clock 12 which is significantly deviated from the correct time is corrected to match the time server 30 during the initial setup of the digital multifunction center 10. Thus, it is possible to communicate using the secret key and the self-signed certificate having correct issue date after the time correction.

A second additional process relates to a delayed job. Many recently-developed digital multifunction centers 10 allow designation of execution date and time of a job such as print output and facsimile transmission. While an ordinary job is normally executed as soon as the other jobs which are present in a queue when the job is sent to the digital multifunction center are completed, for a delayed job, on the other hand, execution of the job is delayed until a designated execution date and time. The form of designation of the execution date and time of the job include an absolute designation in which the absolute date including year, month, day, and time are designated, and a relative designation indicating the relative time from the current time such as a designated number of hours later. In the latter case, that is, a job in which the execution date and time are designated by a relative designation, if the internal clock 12 is significantly corrected, the job may be executed at a time greatly differing from that desired by the user who designated the time.

In consideration of such a situation, in the second additional process, a control program of the digital multifunction center 10 monitors a change of the time of the internal clock 12. When the control program detects that the time displayed by the internal clock 12 has been significantly changed through a time correction process, the control program corrects designation times of execution of delayed jobs by an amount corresponding to the correction of the time. A function to execute such an additional process is provided in the digital multifunction center 10 so that it is possible to allow a job to be executed at the time intended by the user when, for example, an internal clock 12 misset during initial setup is corrected to match the time server 30, because the designated time of execution of the delayed job registered before the time correction is corrected. In the case of the job in which the time is designated by absolute designation, the designated time itself is what the user intends, and, thus, it may be preferable not to change the designated time even when a significant time correction is applied. The control program managing the delayed job may also store information of whether the designated time of each delayed job is absolute designation or relative designation and that the designated time is corrected only for jobs with relative designation according to the time correction when the time correction process is performed.

It is also possible to combine the configurations described above. In a combined method, for example, when the time information obtained from the secondary server in the second configuration differs from the internal clock 12 by an mount greater than or equal to the time deviation tolerance 144 (S34), the time correction flag 148 is checked as in the first configuration and the time correction of the internal clock 12 by the time information is permitted only when the time correction flag 148 indicates that the time correction has not been performed.

In the configurations described above, an alert is sent when the number of suspensions of time correction reaches a predetermined value. It is also possible to employ a configuration in which the alert is sent when the time correction is suspended even once.

In the above description, a digital multifunction center 10 is exemplified as a device having an internal clock. The present invention, however, is not limited to such a device and may be applied to correction of an internal clock of various network devices such as a network printer and facsimile device.

Examples of the present invention have been described. In one configuration of the present invention, a network device includes an internal clock, a time information obtaining section that obtains time information from a time server on the network, a time correcting section that corrects the internal clock based on the time information. When a period of time between the time information and time indicated by the internal clock is less than or equal to a predetermined period of time, the time correcting section corrects the internal clock based on the time information. And when the period of time between the time information and the time indicated by the internal clock exceeds the predetermined period of time, the time correcting section corrects the internal clock based on the time information only if the internal clock has not been corrected.

The network device may further include a counting section that counts a number of time when the internal clock is not corrected in the time correction process by the time correcting section, and an alerting section that outputs an alert when the number counted by the counting section reaches a predetermined value.

In another configuration of the present invention, the network device may further include a self-signed certificate generating section that generates a secret key and a self-signed public key certificate for the network device. The certificate generating section may generate a new secret key and a new self-signed certificate when a period of corrected time exceeds a predetermined period of time.

In a still further configuration of the present invention, the network device may further include a delayed job managing section that manages execution of a delayed job, and a designated time correcting section that corrects a designated time of execution of a delayed job according to a period of corrected time when the period of corrected time exceeds the predetermined period of time.

In another configuration of the present invention, the network device includes an internal clock, a time information obtaining section that obtains time information from a plurality of time servers on the network, and a time correcting section that corrects the internal clock based on the time information. When a period of time between time information obtained from a first time server and time indicated by the internal clock is less than or equal to a predetermined period of time, the time correcting section corrects the internal clock based on the time information obtained from the first time server. When the period of time between the time information obtained from the first time server and the time indicated by the internal clock exceeds the predetermined period of time, the time correcting section corrects the internal clock based on time information obtained from a second time server only if a period of time between the time information obtained from the second time server and the time indicated by the internal clock is less than or equal to the predetermined period of time. If the period of time between the time information obtained from the second time server and the time indicated by the internal clock exceeds the predetermined period of time, the time correcting section corrects the internal clock based on time information obtained from a third time server only if a period of time between the time information obtained from the third time server and the time indicated by the internal clock is less than or equal to the predetermined period of time. It also may be possible to employ another configuration in which when the period of time between the time information obtained from the second server and the time indicated by the internal clock exceeds the predetermined period of time, the time correcting section corrects the internal clock based on the time information obtained from the second time server only if the internal clock has not been corrected.

While the invention has been described in conjunction with specific embodiments, it is evident to those skilled in the art that modifications may be made thereto in light of the foregoing description. Accordingly, it is intended that the appended claims cover all such modifications that fall within the spirit and scope of the invention. The complete disclosure of Japanese Patent Application No. 2005-006839 filed on Jan. 13, 2005, including the specification, claims, drawings, and abstract, is incorporated herein by reference in its entirety.

What is claimed is:

1. A network device which is connected to a network, comprising:
an internal clock;
a time information obtaining section that obtains time information from a time server on the network;
a time correcting section that corrects the internal clock based on the time information; wherein
when a period of time between the time information and time indicated by the internal clock is less than or equal to a predetermined period of time, the time correcting section corrects the internal clock based on the time information, and,
when the period of time between the time information and the time indicated by the internal clock exceeds the predetermined period of time, the time correcting section corrects the internal clock based on the time information only if the internal clock has not been corrected.

2. A network device according to claim 1, further comprising:
a counting section that counts a number of time when the time correcting section does not correct the internal clock; and
an alerting section that outputs an alert when the counted number reaches a predetermined number.

3. A network device according to claim 1, further comprising:
a self-signed certificate generating section that generates a secret key and a self-signed public key certificate for the network device;
when a period of corrected time exceeds a predetermined period of time, the self-signed certificate generating section generates a new secret key and a new self-signed certificate.

4. A network device according to claim 1, further comprising:
a delayed job managing section that manages execution of a delayed job; and
a designated time correcting section that corrects a designated time of execution of a delayed job according to a period of corrected time when the period of corrected time exceeds a predetermined period of time.

5. A network device which is connected to a network, comprising:
an internal clock;
a time information obtaining section that obtains time information from a plurality of time servers on the network; and
a time correcting section that corrects the internal clock based on the time information; wherein
when a period of time between time information obtained from a first time server and time indicated by the internal clock is less than or equal to a predetermined period of time, the time correcting section corrects the internal clock based on the time information obtained from the first time server, and,
when the period of time between the time information obtained from the first time server and the time indicated by the internal clock exceeds the predetermined period of time, the time correcting section corrects the internal clock based on time information obtained from a second time server only if a period of time between the time information obtained from the second time server and the time indicated by the internal clock is less than or equal to the predetermined period of time.

6. The network device according to claim 5, further comprising:
a counting section that counts a number of time when the time correcting section does not correct the internal clock; and
an alerting section that outputs an alert when the counted number reaches a predetermined number.

7. The network device according to claim 5, further comprising:
a self-signed certificate generating section that generates a secret key and a self-signed public key certificate for the network device;
when a period of corrected time exceeds a predetermined period of time, the self-signed certificate generating section generates a new secret key and a new self-signed certificate.

8. The network device according to claim 5, further comprising:
a delayed job managing section that manages execution of a delayed job; and
a designated time correcting section that corrects a designated time of execution of a delayed job according to a period of corrected time when the period of corrected time exceeds a predetermined period of time.

9. A method of correcting an internal clock which is built into a network device, the method comprising:
obtaining time information from a time server on the network; and
correcting the internal clock based on the time information; wherein
when a period of time between the time information and time indicated by the internal clock is less than or equal to a predetermined period of time, the internal clock is corrected based on the time information; and
when the period of time between the time information and the time indicated by the internal clock exceeds the predetermined period of time, the internal clock is corrected only if the internal clock has not been corrected.

10. The method according to claim 9, further comprising:
counting a number of time when the internal clock is not corrected, and outputting an alert when the counted number reaches a predetermined number.

11. The method according to claim 9, further comprising:
generating a secret key and a self-signed public key certificate for the network device;
when a period of corrected time exceeds a predetermined period of time, a new secret key and a new self-signed certificate are generated.

12. The method according to claim 9, further comprising:
correcting a designated time of execution of a delayed job according to a period of corrected time when the period of corrected time exceeds a predetermined period of time.

13. A method of correcting an internal clock which is built into a network device, comprising:
obtaining time information from a plurality of time servers on the network; and
correcting the internal clock based on the time information; wherein
when a period of time between time information obtained from a first time server and time indicated by the internal clock is less than or equal to a predetermined period of time, the internal clock is corrected based on the time information, and
when the period of time between the time information obtained from the first time server and the time indicated by the internal clock exceeds the predetermined period of time, the internal clock is corrected based on time information obtained from a second time server only if a period of time between the time information obtained from the second time server and the time indicated by the internal clock is equal to or less than the predetermined period of time.

14. The method according to claim 13, further comprising:
counting a number of time when the internal clock is not corrected; and
outputting an alert when the counted number reaches a predetermined number.

15. The method according to claim 13, further comprising:
generating a secret key and a self-signed public key certificate for the network device;
when a period of corrected time exceeds a predetermined period of time, a new secret key and a new self-signed certificate are generated.

16. The method according to claim 13, further comprising:
correcting a designated time of execution of a delayed job according to a period of corrected time when the period of corrected time exceeds a predetermined period of time.

17. A storage medium readable by a computer, the storage medium storing a program of instructions executable by the computer having an internal clock to perform a function comprising:
obtaining time information from a time server on the network; and
correcting the internal clock based on the time information; wherein
when a period of time between the time information and time indicated by the internal clock is less than or equal to a predetermined period of time, the internal clock is corrected based on the time information; and
when the period of time between the time information and the time indicated by the internal clock exceeds the predetermined period of time, the internal clock is corrected only if the internal clock has not been corrected.

18. The storage medium according to claim 17, the function further comprising:
counting a number of time when the internal clock is not corrected; and outputting an alert when the counted number reaches a predetermined number.

19. The storage medium according to claim 17, the function further comprising:
generating a secret key and a self-signed public key certificate for the network device;
when a period of corrected time exceeds a predetermined period of time, a new secret key and a new self-signed certificate are generated.

20. The storage medium according to claim 17, the function further comprising:
correcting a designated time of execution of a delayed job according to a period of corrected time when the period of corrected time exceeds a predetermined period of time.

21. A storage medium readable by a computer, the storage medium storing a program of instructions executable by the computer having an internal clock to perform a function comprising:
obtaining time information from a plurality of time servers on the network; and
correcting the internal clock based on the time information; wherein
when a period of time between time information obtained from a first time server and time indicated by the internal clock is less than or equal to a predetermined period of time, the internal clock is corrected based on the time information, and
when the period of time between the time information and the time indicated by the internal clock exceeds the predetermined period of time, the internal clock is corrected based on time information obtained from a second time server only if a period of time between the time information obtained from the second time server and the time indicated by the internal clock is equal to or less than the predetermined period of time.

22. The storage medium according to claim 21, the function further comprising:
counting a number of time when the internal clock is not corrected, and outputting an alert when the counted number reaches a predetermined number.

23. The storage medium according to claim 21, the function further comprising:
generating a secret key and a self-signed public key certificate for the network device;
when a period of corrected time exceeds a predetermined period of time, a new secret key and a new self-signed certificate are generated.

24. The storage medium according to claim 21, the function further comprising:
correcting a designated time of execution of a delayed job according to a period of corrected time when the period of corrected time exceeds a predetermined period of time.

25. The network device according to claim 5, wherein:
when the period of time between the time information obtained from the second time server and the time indicated by the internal clock exceeds the predetermined period of time, the time correcting section corrects the internal clock based on time information obtained from a third time server only if a period of time between the time information obtained from the third time server and the time indicated by the internal clock is less than or equal to the predetermined period of time.

26. The network device according to claim 5, wherein:
when the period of time between the time information obtained from the second server and the time indicated by the internal clock exceeds the predetermined period of time, the time correcting section corrects the internal clock based on the time information obtained from the second time server only if the internal clock has not been corrected.

27. A network device which is connected to a network, comprising:
an internal clock;
a time information obtaining section that obtains time information from a time server on the network;
a time correcting section that corrects the internal clock based on the time information; wherein
when a period of time between the time information and time indicated by the internal clock is less than or equal to a predetermined period of time, the time correcting section corrects the internal clock based on the time information.
